(19) United States
(12) Patent Application Publication
(10) Pub. No.: US 2016/0072156 A1
(43) Pub. Date: Mar. 10, 2016

(54) Universal cell

(71) Applicant: Chao-Cheng Lu, Taipei (TW)

(72) Inventor: Chao-Cheng Lu, Taipei (TW)

(21) Appl. No.: 14/121,453

(22) Filed: Sep. 9, 2014

(51) Int. Cl. H01M 10/42

(52) U.S. Cl. CPC H01M 10/4257; H01M 2010/4271

(57) ABSTRACT

This invention is related to a universal cell, the universal cell includes a positive terminal, a first conductor, a voltage balance circuit, a positive tab, an electrode spiral, a negative tab, a negative terminal, and battery container. The universal cell utilizes a characteristic of voltage balance circuit that the universal cell can be connected with another universal cell in parallel without generating a current-circulation loss at an idle state, a charge state, or a discharge state.

### FIELD OF THE INVENTION

The present invention relates to a universal cell, in particular a universal cell to converter a chemical energy of a cell to electrical energy, the present invention utilizes a characteristic of voltage balance circuit that connect with a purity of universal cells in parallel for eliminating a current-circulation loss generated by the battery work at an idle state, a charge state and a discharge state.

### BACKGROUND OF THE INVENTION

Traditional, reference to FIG. 1, FIG. 1 is shown as sectional view of a battery of prior art.

Reference to prior art, the battery is a lithium ion cell 2 comprises a cell cap subassembly 22, a positive terminal 24, a positive tab 26, an insulator 28, an electrode spiral 210, a negative tab 212, a negative terminal 214, and a battery container 216. The prior art discloses a method for connecting the positive tab 26 with the positive terminal 24. In addition, it also reference to other prior arts.

However, the prior arts show some disadvantage:

1) In a situation of a plurality of battery are connected in parallel, the batteries work at a charge state, since the batteries have different voltage level, the batteries result in generating a current-circulation loss.

2) Under same situation as 1), when the batteries work at a discharge state, it also generates the current-circulation loss.

3) Under same situation as 1), when the batteries don't work at the charge state and the discharge state, the batteries connected each other also generate current-circulation loss until the energy of the batteries are exhausted.

However, any of the above-mentioned situations, it will reduce the effect of charge/discharge, and it is inconvenient for using.

Therefore, a universal cell is revealed in this invention to resolve the drawbacks of the prior arts. Wherein the universal cell with a voltage balance circuit.

### SUMMARY OF THE INVENTION

The first objective of this invention is to reveal a universal cell, utilizes a plurality of cell embedded a diode (forward voltage drop or barrier voltage) to eliminate current-circulation loss at the plurality are connected in parallel.

The second objective of this invention is to reveal the universal cell, the voltage balance circuit is configured to a battery container for easily to be carried and be replaced.

The third objective of this invention is to reveal the universal cell, is capable to apply to power system within a vehicle, a power storage, and a mobile communication device.

To achieve the abovementioned objectives or others, this invention reveals a universal cell, it includes some technical features, as shown below.

The present invention disclose that a voltage balance circuit of a first diode is connected with a second diode through an Electrically-Parallel-Coupled, and the voltage balance circuit is configured to a space of a battery container. In the battery container, the voltage balance circuit is configured to between an electrode spirals with a positive terminal for removing a current-circulation loss when a pluralities of battery are connected in parallel.

The present invention disclose that a voltage balance circuit of a first diode is connected with a second diode in reverse, the voltage balance circuit is configured to between an electrode spiral with a negative terminal for removing a current-circulation loss when a plurality of battery are connected in parallel.

The diode is one of a P-N junction diode, a Schottky diode, a Zener diode, a Varactor diode, a Tunnel diode, and an instantaneous voltage protective diode.

The universal cell is a secondary cell. When a plurality of secondary cell are connected each other in parallel, the plurality of secondary cell don't generate a current-circulation loss, wherein plurality of secondary cell are works at an idle state, a charge state or a discharge state.

The universal cell is also a primary cell. When a plurality of primary cell are connected each other in parallel, they also don't generate that current-circulation loss.

In the embodiment of present invention, the shape structure of battery container is classified as 18650 battery. However, 18650 battery is just for describing, not limited. On the other hand, the shape structure of battery container may be replaced by shape of a lithium battery. For example, the shape structure of lithium battery is a cylinder type, a square type, an aluminum plastic Composite membrane packaging form, etc.

### BRIEF DESCRIPTION OF THE DRAWINGS

FIG. 1 illustrate a sectional view of a battery of the prior art.

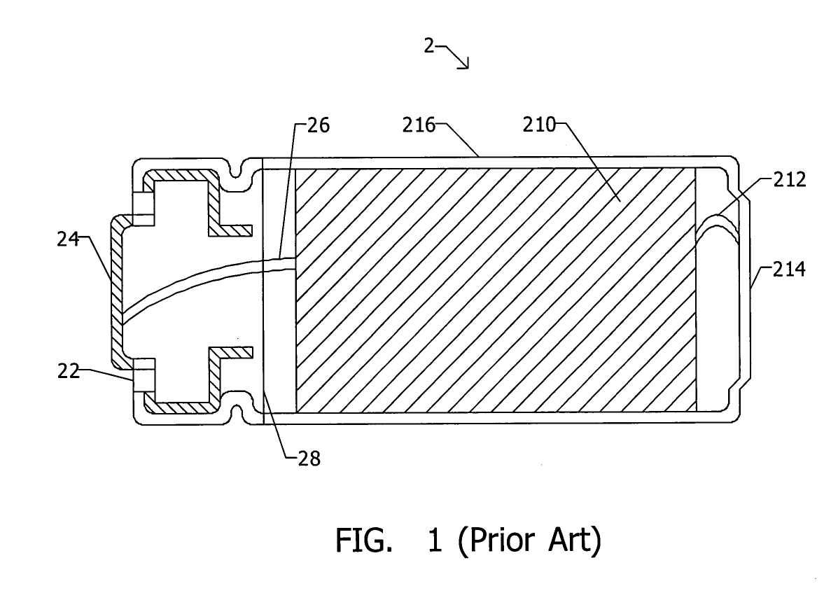

FIG. 2 illustrate a sectional view of universal cell of first embodiment of the present invention.

FIG. 3 shows the voltage balance circuit of FIG. 2 of present invention.

FIG. 4 illustrate a sectional view of universal cell of second embodiment of the present invention.

### DETAILED DESCRIPTION OF THE PREFERRED EMBODIMENTS

To fully understand the objectives, the features and the effects of the invention, several embodiments are disclosed hereinafter in conjunction with the accompanying drawings to interpret the invention in detail.

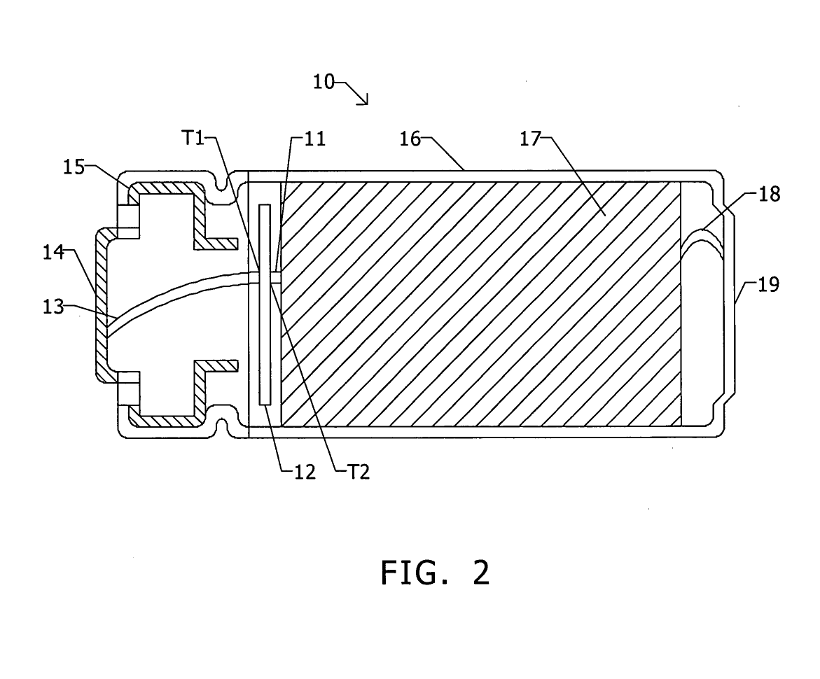

Refer to FIG. 2, illustrate a sectional view of universal cell of first embodiment of the present invention. In FIG. 2, the universal cell 10 includes a positive terminal 14, a first conductor 13, a voltage balance circuit 12, a positive tab 11, an electrode spiral 17, a negative tab 18, a negative terminal 19, and a battery container 16.

The positive terminal 14 is connected with an external first circuit (not shown).

The first conductor 13 includes two terminals. One terminal of the first conductor 13 is connected with the positive terminal 14, and another terminal of the first conductor 13 is connected with a terminal of the voltage balance circuit 12.

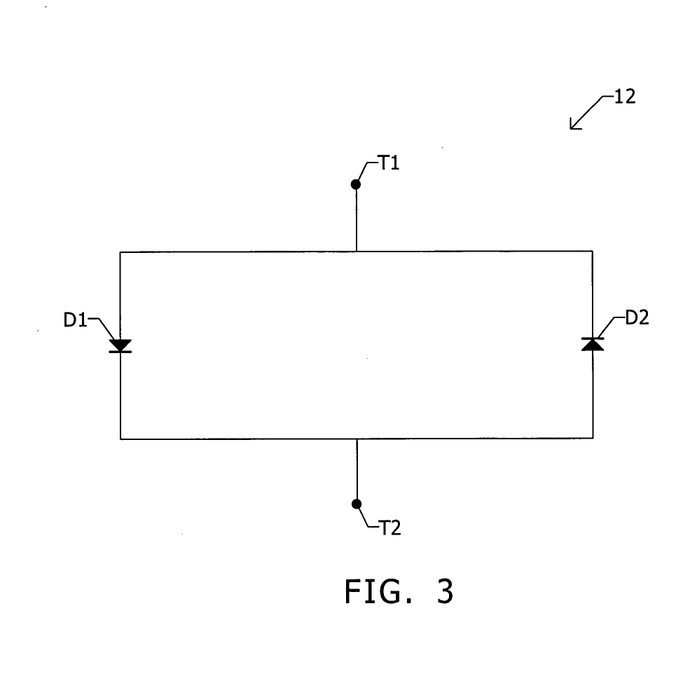

The voltage balance circuit 12 includes two terminals T1, T2. The terminal T1 of the voltage balance circuit 12 is connected with another terminal of the first conductor 13, and another terminal T2 of the voltage balance circuit 12 is connected with a terminal of the positive tab 11. The detail structure of voltage balance circuit 12 is shown as FIG. 3. FIG. 3 shows the voltage balance circuit of FIG. 2 of present invention.

In FIG. 3, the voltage balance circuit 12 includes a first diode D1 and a second diode D2. The first diode D1 and the second diode D2 can be one of a P-N junction diode, a Schottky diode, a Zener diode, a Varactor diode, a Tunnel diode, and an instantaneous voltage protective diode. The first diode D1 includes a first anode terminal and a first cathode terminal. The second diode D2 includes a second anode terminal and a second cathode terminal. The second anode terminal is connected with the first cathode terminal, and the second cathode terminal is connected with the first anode terminal. Wherein, the first anode terminal and the second cathode terminal are formed as the terminal T1 of the voltage balance circuit 12, and the first cathode terminal and the second anode terminal are formed as another terminal T2 of the voltage balance circuit 12.

In charge state (e.g. direction of a current is from T1 to T2), the first diode D1 is ON, and the second diode D2 is cut off via the voltage balance circuit 12; on the contrary, in discharge state (e.g. direction of a current is from T2 to T1), the first diode D1 is cut off, and the second diode D2 is ON via the voltage balance circuit 12.

Back to FIG. 2, the positive tab 11 includes two terminals. One terminal of the positive tab 11 is connected with another terminal T2 of the voltage balance circuit 12, and another terminal of the positive tab 11 is connected with one terminal of the electrode spiral 17.

The electrode spiral 17 includes two terminals. One terminal of the electrode spiral 17 is connected with another terminal of the positive tab 11, and another terminal of the electrode spiral 17 is connected with one terminal of the negative tab 18.

The negative tab 18 includes two terminals. One terminal of the negative tab 18 is connected with another terminal of the electrode spiral 17, and another terminal of the negative tab 18 is connected with one terminal of the negative terminal 19.

The negative terminal 19 includes two terminals. One terminal of the negative terminal 19 is connected with another terminal of the negative tab 18, and another terminal of the negative terminal 19 is connected with an external second circuit (not shown).

The battery container 16 is forming a space, the space contains the voltage balance circuit 12, the positive tab 11, the electrode spiral 17, and the negative tab 18.

It is worthy to understanding, the universal cell 10 further includes an insulator 15, the insulator 15 fixes the positive terminal 14.

Main functions of the positive terminal 14 and the negative terminal 19 of the universal cell 10, includes two parts, one part is that the battery works at a discharge state or a charge state for enabling to connected with an external circuit (e.g. a power circuit or a loading circuit); another part is connecting with another universal cell 10 in series or in parallel.

Since the universal cell 10 includes the voltage balance circuit 12, when a plurality of universal cell 10 connected each other in series or in parallel, the universal cell 10 cannot generate a current-circulation loss.

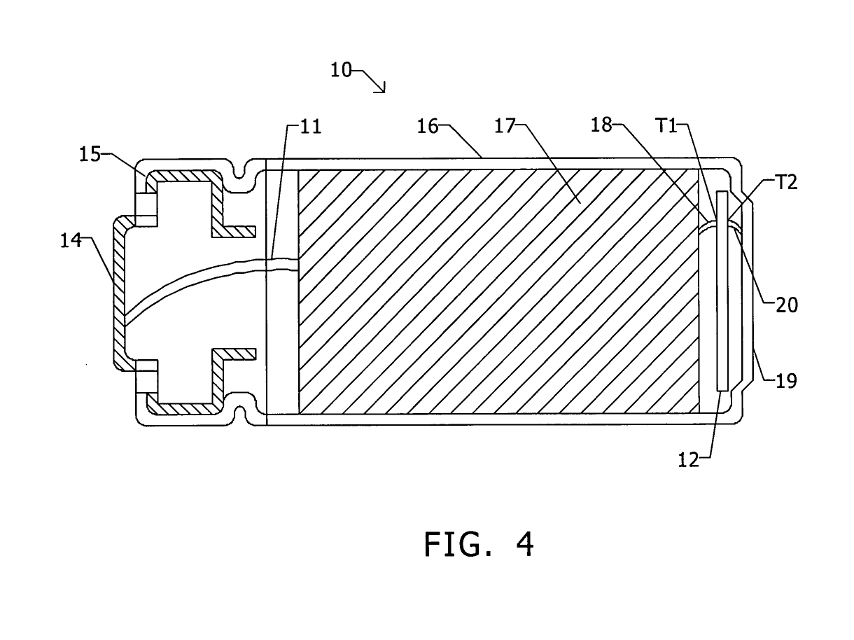

Refer to FIG. 4, illustrate a sectional view of universal cell of second embodiment of the present invention. In FIG. 4, the universal cell 10 includes a positive terminal 14, a positive tab 11, an electrode spiral 17, a negative tab 18, a voltage balance circuit 12, a negative terminal 19, a second conductor 20, and a battery container 16.

The positive terminal 14 is connected with an external first circuit (not shown).

The positive tab 11 includes two terminals, one terminal of the positive tab 11 is connected with the positive terminal 14, and another terminal of the positive tab 11 is connected with the electrode spiral 17.

The electrode spiral 17 includes two terminals, one terminal of the electrode spiral 17 is connected with another terminal of the positive tab 11, and another terminal of the electrode spiral 17 is connected with one terminal of the negative tab 18.

The negative tab 18 includes two terminals, one terminal of the negative tab 18 is connected with another terminal of the electrode spiral 17, and one terminal of the negative tab 18 is connected with one terminal T1 of the voltage balance circuit 12.

The voltage balance circuit 12 includes two terminals T1, T2. The one terminal T1 of the voltage balance circuit 12 is connected with another terminal of the negative tab 18, and another terminal T2 of the voltage balance circuit 12 is connected with one terminal of the second conductor 20.

The second conductor 20 include two terminals, one terminal of the second conductor 20 is connected with another terminal T2 of the voltage balance circuit 12, another of the second conductor 20 is connected with one terminal of the negative terminal 19.

The negative terminal 19 includes two terminals, one terminal of the negative terminal 19 is connected with another terminal of the second conductor 20, and another terminal of the negative terminal 19 is connected with external second circuit (not shown). The battery container 16 forms a space. The space contains the positive tab 11, the electrode spiral 17, the negative tab 18, the second conductor 20, and the voltage balance circuit 12. The battery container 16 can be used as the negative terminal 19.

Refer to FIG. 2 and FIG. 4, the universal cell 10 further includes an insulator 15 for providing the battery container 16 to fix the positive terminal 14.

It is worthy to understanding, the voltage balance circuit 12 in FIG. 3 includes a first diode D1 and a second diode D2. The voltage balance circuit 12 can be used for working at a charge state or a discharge state. Namely, the voltage balance circuit 12 can be used to a secondary cell.

If the voltage balance circuit 12 applies to primary cell, it just works at discharge states. Therefore, the voltage balance circuit 12 just utilizes a single second diode D2.

This invention is disclosed by the preferred embodiments above, but a person having ordinary skill in the art shall understand that, the embodiments are used only to describe this invention rather than to limit this invention. It should be noted that, those equivalent or substantially equivalent replacements or changes shall be covered by this invention. The protection range of this invention shall be therefore subject to the claims thereinafter.

What is claimed is:

1. A universal cell having the ability to connect in parallel without current-circulation loss, said universal cell comprising:
a positive terminal;
a first conductor, having two terminals, one terminal of said first conductor connect is connected with said positive terminal;
a voltage balance circuit, having two terminals, one terminal of said voltage balance circuit is connected with another terminal of said first conductor;
a positive tab, having two terminals, one terminal of said positive tab is connected with another terminal of said voltage balance circuit;
an electrode spiral, having two terminals, one terminal of said electrode spiral is connected with another terminal of said positive tab;
a negative tab, having two terminals, one terminal of said negative tab is connected with another terminal of said electrode spiral;
a negative terminal, having two terminals, one terminal of said negative terminal is connected with another terminal of said negative tab; and
a battery container, formed a space, the space contains said voltage balance circuit, said positive tab, said electrode spiral, and said negative tab, wherein said battery container fix said positive terminal via an insulator.

2. A universal cell according to claim 1, wherein said voltage balance circuit comprising:
a first diode, having a first anode terminal and a first cathode terminal; and
a second diode, having a second anode terminal and a second cathode terminal, said second anode terminal is connected with said first cathode terminal, and said second cathode terminal is connected with said first anode terminal;
Wherein said first anode terminal and said second cathode terminal are formed as one terminal of said voltage balance circuit, and said first cathode terminal and said second anode terminal are formed as another terminal of said voltage balance circuit.

3. A universal cell according to claim 2, wherein said first diode is one of a P-N junction diode, a Schottky diode, a Zener diode, a Varactor diode, a Tunnel diode, and an instantaneous voltage protective diode.

4. A universal cell according to claim 2, wherein said second diode is one of a P-N junction diode, a Schottky diode, a Zener diode, a Varactor diode, a Tunnel diode, and an instantaneous voltage protective diode.

5. A universal cell according to claim 2, wherein said voltage balance circuit comprising:
a second diode, having a second anode terminal and a second cathode terminal, said second cathode terminal is formed as one terminal of said voltage balance circuit, and said second anode terminal is formed as another terminal of said voltage balance circuit.

6. A universal cell having the ability to connect in parallel without current-circulation loss, said universal cell comprising:
a positive terminal;
a positive tab, having two terminals, one terminal of said positive tab is connected with said positive terminal;
an electrode spiral, having two terminals, one terminal of said electrode spiral is connected with another terminal of said positive tab;
a negative tab, having two terminal, one terminal of said negative tab is connected with another terminal of said electrode spiral;
a voltage balance circuit, having two terminals, one terminal of said voltage balance circuit is connected with another terminal of said negative tab;
a second conductor, having two terminals, one terminal of said second conductor is connected with another terminal of said voltage balance circuit;
a negative terminal, having two terminal, one terminal of said negative terminal is connected with another terminal of said second conductor; and
a battery container, formed a space, the space contains said positive tab, said electrode spiral, said negative tab, and said diode circuit, wherein said battery container fix said positive terminal via an insulator.

7. A universal cell according to claim 6, wherein said voltage balance circuit comprising:
a first diode, having a first anode terminal and a first cathode terminal; and
a second diode, having a second anode terminal and a second cathode terminal, said second anode terminal is connected with said first cathode terminal, and said second cathode terminal is connected with said first anode terminal;
Wherein said first anode terminal and said second cathode terminal are formed as one terminal of said voltage balance circuit, and said first cathode terminal and said second anode terminal are formed as another terminal of said voltage balance circuit.

8. A universal cell according to claim 7, wherein said first diode is one of a P-N junction diode, a Schottky diode, a Zener diode, a Varactor diode, a Tunnel diode, and an instantaneous voltage protective diode.

9. A universal cell according to claim 7, wherein said second diode is one of a P-N junction diode, a Schottky diode, a Zener diode, a Varactor diode, a Tunnel diode, and an instantaneous voltage protective diode.

10. A universal cell according to claim 7, wherein the voltage balance circuit comprising:
a second diode, having a second anode terminal and a second cathode terminal, said second cathode terminal is formed as one terminal of said voltage balance circuit; and said second anode terminal is formed as another terminal of said voltage balance circuit.
